(19) United States
(12) Patent Application Publication
(10) Pub. No.: US 2025/0360858 A1
(43) Pub. Date: Nov. 27, 2025

(54) Marine-Grade Accessory Holder and Power Delivery System

(71) Applicant: AQUA-AMP, LLC, Clearwater, FL (US)

(72) Inventors: Robert James Wellden, Clearwater, FL (US); Gregory Bernard PIckren, Oldsmar, FL (US); Ryan Gregory Pickren, Atlanta, GA (US)

(21) Appl. No.: 19/188,068

(22) Filed: Apr. 24, 2025

Related U.S. Application Data
(60) Provisional application No. 63/651,740, filed on May 24, 2024.

(51) Int. Cl. B60N 3/10; B60Q 3/225

(52) U.S. Cl. CPC B60N 3/101; B60Q 3/229; B60N 2230/20

(57) ABSTRACT

An example of a cupholder includes a tubular receptacle with a first open end, a second capped end, and a sidewall therebetween. The second capped end defines a central drain port. The cupholder further includes an annular PCB adjacent the second capped end, the annular PCB having a central aperture. The central drain port extends through the central aperture.

### CROSS-REFERENCE TO RELATED APPLICATION

This claims the benefit of priority from U.S. provisional Application No. 63/651,740, filed May 24, 2024, which is hereby incorporated by reference in its entirety.

### FIELD

This disclosure relates to marine accessories, specifically a marine-grade accessory holder and power delivery system.

### BACKGROUND

Accessory holders can support items such as bottles, cups, or mugs, or electronics such as phones, tablets, or navigational aids. These accessory holders can be mounted in a variety of vehicles, such as boats or cars. Accessory holders are designed to provide passengers ready access to the accessory, while at the same time holding the accessory in a secure manner.

However, a problem with conventional accessory holders is that they do not include an apparatus for delivering power to an accessory in a marine environment.

### BRIEF SUMMARY

It is therefore one of the objectives of this disclosure to provide a marine-grade cupholder and power delivery system for various types of boats and watercraft.

A first example of a cupholder includes a tubular receptacle with a first open end, a second capped end, and a sidewall therebetween. The second capped end defines a central drain port. The cupholder further includes an annular PCB adjacent the second capped end, the annular PCB having a central aperture. The central drain port extends through the central aperture.

The cupholder may also include one or more of the following features.

The cupholder may include an inductive loop adjacent the second capped end.

The cupholder may include an accessory with a tubular body, the tubular body having a connection portion configured to fit within the tubular receptacle, and an inductive loop within the connection portion.

The annular PCB may include a NFC module.

The annular PCB may be coated in an insulative, waterproof material.

The cupholder may include an annular LED module within the tubular receptacle.

The sidewall may have an inner surface and an outer surface. The cupholder may include a first conductive ring embedded in the sidewall and extending radially from the inner surface toward the outer surface. The cupholder may also include a second conductive ring embedded in the sidewall and extending radially from the inner surface toward the outer surface. The second conductive ring may be a distance from the first conductive ring.

The cupholder may include an accessory with a tubular body, the tubular body having a connection portion configured to fit within the tubular receptacle.

The sidewall may have an inner surface and an outer surface. The cupholder may include a first conductive ring embedded in the sidewall and extending radially from the inner surface toward the outer surface. The cupholder may include a second conductive ring embedded in the sidewall and extending radially from the inner surface toward the outer surface. The second conductive ring may be a distance from the first conductive ring. The cupholder may include an accessory with a tubular body, the tubular body having a connection portion configured to fit within the tubular receptacle. The connection portion may have an exterior surface, a first loop of conductive ribbon, and a second loop of conductive ribbon. The first loop of conductive ribbon and second loop of conductive ribbon may be embedded in the tubular body and have respective contact portions that extend beyond the exterior surface. The second loop of conductive ribbon may be the distance from the first loop of conductive ribbon.

The cupholder may include a first NFC module on the annular PCB and an accessory with a tubular body. The tubular body may have a connection portion configured to fit within the tubular receptacle, the connection portion having a second NFC module. The annular PCB may be programmed to allow current to flow through the tubular receptacle and the connection portion when the first NFC module and second NFC module are separated by less than a threshold distance.

A second example of a cupholder includes a tubular receptacle with a first open end, a second capped end, and a sidewall therebetween, the sidewall having an inner surface and an outer surface. The cupholder includes a first conductive ring embedded in the sidewall and extending radially from the inner surface toward the outer surface. The cupholder includes a second conductive ring embedded in the sidewall and extending radially from the inner surface toward the outer surface. The second conductive ring is a distance from the first conductive ring.

The cupholder may also include one or more of the following features.

The cupholder may include an annular PCB adjacent the second capped end.

The annular PCB may be coated in an insulative, waterproof material.

The second capped end may define a central drain port that extends through the annular PCB.

The cupholder may include an annular LED module within the tubular receptacle.

The cupholder may include an annular PCB adjacent the second capped end that includes a NFC module.

The cupholder may include an accessory with a tubular body, the tubular body having a connection portion configured to fit within the tubular receptacle. The connection portion may have an exterior surface, a first loop of conductive ribbon, and a second loop of conductive ribbon. The first loop of conductive ribbon and second loop of conductive ribbon may be embedded in the tubular body and have respective contact portions that extend beyond the exterior surface. The second loop of conductive ribbon may be the distance from the first loop of conductive ribbon.

The cupholder may include an accessory with a tubular body, the tubular body having a connection portion configured to fit within the tubular receptacle. The connection portion may have an exterior surface, a first loop of conductive ribbon, and a second loop of conductive ribbon. The first loop of conductive ribbon and second loop of conductive ribbon may be embedded in the tubular body and have respective contact portions that extend beyond the exterior surface. The second loop of conductive ribbon may be the distance from the first loop of conductive ribbon. The first loop of conductive ribbon and the second loop of conductive ribbon may be in substantially parallel planes.

The cupholder may include an annular PCB adjacent the second capped end. The annular PCB may include a first NFC module. The cupholder may include an accessory with a tubular body, the tubular body having a connection portion configured to fit within the tubular receptacle. The connection portion may have a second NFC module. The annular PCB may be programmed to allow current to flow from the first conductive ring through the accessory to the second conductive ring when the first NFC module and second NFC module are separated by less than a threshold distance.

A third example of a cupholder includes a tubular receptacle with a first open end, a second capped end, and a sidewall therebetween. The sidewall has an inner surface and an outer surface. The second capped end defines a central drain port. The cupholder includes an annular PCB adjacent the second capped end, the annular PCB having a central aperture and a first NFC module. The annular PCB is coated in an insulative, waterproof material. The central drain port extends through the central aperture. A first conductive ring is embedded in the sidewall and extends radially from the inner surface toward the outer surface. A second conductive ring is embedded in the sidewall and extends radially from the inner surface toward the outer surface. The second conductive ring is a distance from the first conductive ring. The cupholder includes an annular LED module within the sidewall and an accessory with a tubular body. The tubular body has a connection portion configured to fit within the tubular receptacle. The connection portion has a second NFC module, an exterior surface, a first loop of conductive ribbon, and a second loop of conductive ribbon. The first loop of conductive ribbon and second loop of conductive ribbon are embedded in the tubular body and have respective contact portions that extend beyond the exterior surface. The second loop of conductive ribbon is the distance from the first loop of conductive ribbon. The first loop of conductive ribbon and the second loop of conductive ribbon are in substantially parallel planes. The annular PCB is programmed to allow current to flow from the first conductive ring through the first loop of conductive ribbon and second loop of conductive ribbon to the second conductive ring when the first NFC module and second NFC module are separated by less than a threshold distance.

Various embodiments of the invention may achieve none, some, or all of these objectives. Other technical advantages of the present disclosure will be readily apparent to one skilled in the art.

### BRIEF DESCRIPTION OF THE DRAWINGS

FIG. 1 is a perspective view of an example of a cupholder.

FIG. 2 is a top perspective view thereof.

FIG. 3 is a bottom perspective view thereof.

FIG. 4 is a side view thereof.

FIG. 5 is a bottom view thereof.

FIG. 6 is a top view thereof.

FIG. 7 is a side cross-section view thereof.

FIG. 8 is a perspective view of an example of conductive rings and an annular PCB.

FIG. 9 is a perspective view thereof, wherein the conductive rings are shown connected to a battery.

FIG. 10 is a perspective exploded view of the example of a cupholder.

FIG. 11 is a perspective cross-section exploded view thereof.

FIG. 12 is a top view of an example of an annular PCB.

FIG. 13 is a perspective view thereof.

FIG. 14 is a perspective view thereof, wherein the annular PCB is coated in an insulative, waterproof material.

FIG. 15 is a cross section view thereof.

FIG. 16 is a side view of an example of an accessory.

FIG. 17 is a perspective view of the example of a cupholder with the example of an accessory mounted therein.

FIG. 18 is a side cross-section view thereof.

FIG. 19 is an enlarged, side cross-section view of a portion thereof, the portion indicated by a broken-line circle in FIG. 18.

FIG. 20 is a side cross section view of the example of a cupholder with the example of an accessory partially inserted into the cupholder.

FIG. 21 is a side cross section view of the example of a cupholder with the example of an accessory fully inserted into the cupholder.

FIG. 22 is a side view of a second example of a cupholder.

FIG. 23 is a side view of a second example of an accessory.

FIG. 24 is a side cross-section view of the second example of a cupholder with the second example of an accessory mounted therein.

FIG. 25 is a perspective view of a cupholder mounted on a boat.

### DETAILED DESCRIPTION

This disclosure describes examples and features, but not all possible examples

and features of the cupholder. Where a particular feature is disclosed in the context of a particular example, that feature can also be used, to the extent possible, in combination with and/or in the context of other examples. The cupholder may be embodied in many different forms and should not be construed as limited to only the examples and features described here.

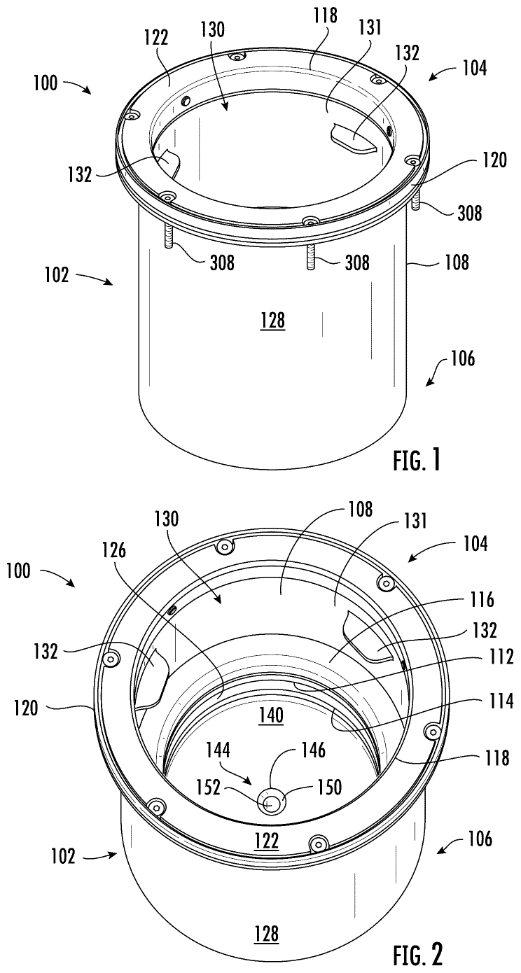

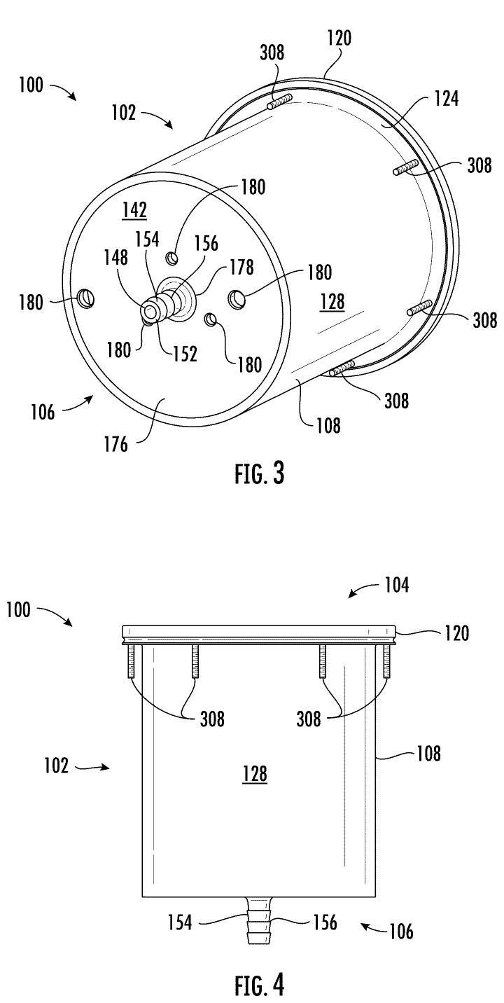

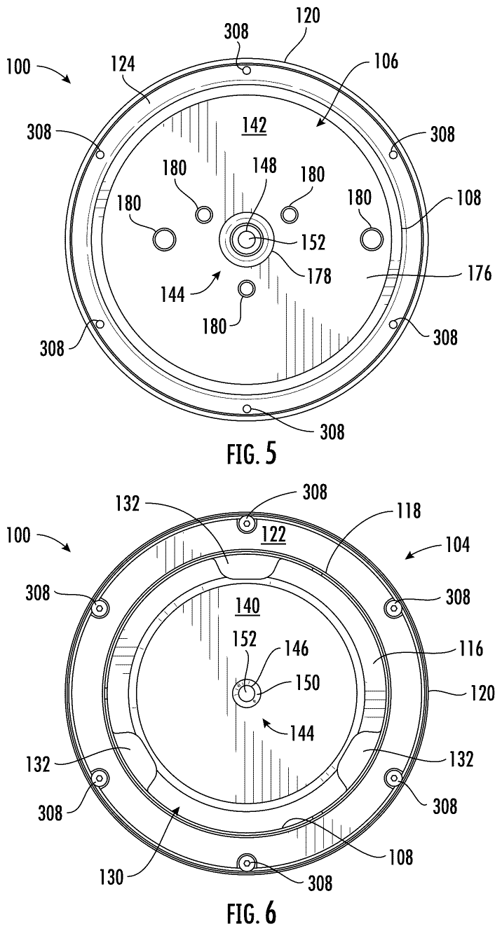

Referring to FIGS. 1-7, the example of a cupholder 100 includes a tubular receptacle 102 with a first open end 104 and a second capped end 106. A sidewall 108 is between the first open end 104 and the second capped end 106. A printed circuit board (PCB) 110 is adjacent the second capped end 106. The cupholder 100 also includes a first conductive ring 112, a second conductive ring 114, and a light-emitting diode (LED) module 116.

In the example shown, the first open end 104 defines a circular top opening 118. The top opening 118 is sized such that it can receive a beverage container therethrough. The beverage container may be a soda can, a plastic cup, a glass, a tumbler, or the like. The first open end 104 also includes a radially enlarged lip 120. The radially enlarged lip 120 extends from a top face 122 to a mounting face 124. When the cupholder 100 is installed in a hole in a vehicle body, the radially enlarged lip 120 prevents the cupholder 100 from falling through the hole. The mounting face 124 is configured to sit flush with a surface of the vehicle body.

In the example shown, the sidewall 108 has an inner surface 126 and an outer surface 128. The sidewall 108 defines an inner volume 130. The inner volume 130 is configured to receive a beverage container, such as a soda can, a plastic cup, a glass, a tumbler, or the like. The sidewall 108 also includes a sidewall insert 131 with protrusions 132 which protrude into the inner volume 130. The sidewall insert 131 may be made of rubber or a soft polymer. The protrusions 132 are configured to contact the beverage container and limit its movement within the inner volume 130. The inner surface 126 defines a radially enlarged section 134 adjacent the first open end 104 and a radially constricted section 136 adjacent the second capped end 106. The radially enlarged section 134 terminates at a shoulder 138 between the radially enlarged section 134 and radially constricted section 136.

In the example shown, the LED module 116 is ring-shaped, but it may also be other shapes or a plurality of isolated LED bulbs. The LED module 116 contacts the shoulder 138. The LED module 116 illuminates the inner volume 130. The LED module 116 may emit one color of light or multiple colors.

In the example shown, the second capped end 106 includes an inside face 140 and an outside face 142 and defines a central drain port 144. The central drain port 144 includes an inside aperture 146 and an outside aperture 148. A bevel 150 is adjacent the inside aperture 146. A lumen 152 extends from the inside aperture 146 to the outside aperture 148. The central drain port 144 allows liquid to escape from the inner volume 130 through the lumen 152. A connection surface 154 extends from the outside face 142 to the outside aperture 148. The connection surface 154 includes a texture 156. The texture 156 is configured to provide friction when a tube is placed around the connection surface 154 to direct liquid exiting the outside aperture 148.

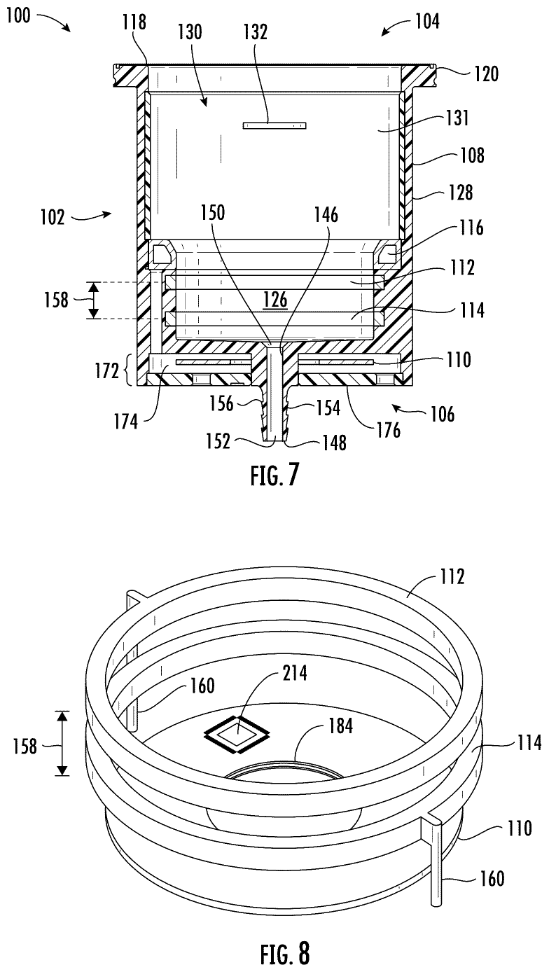

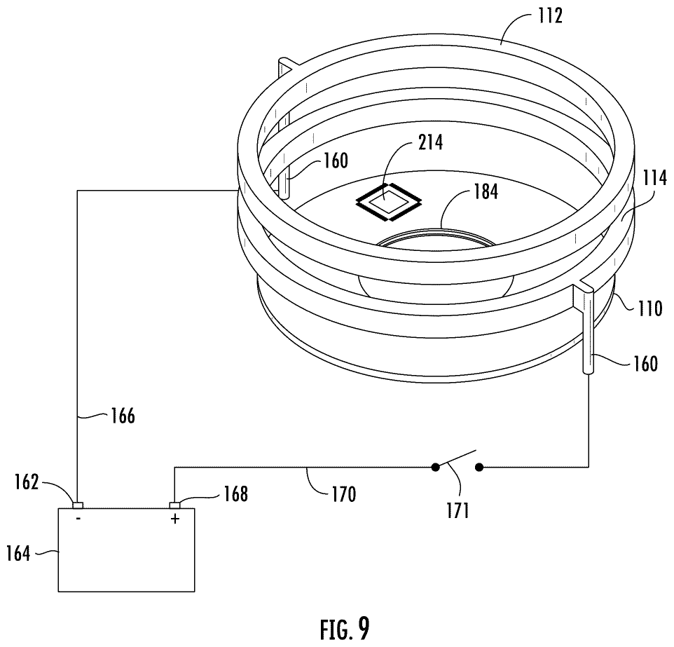

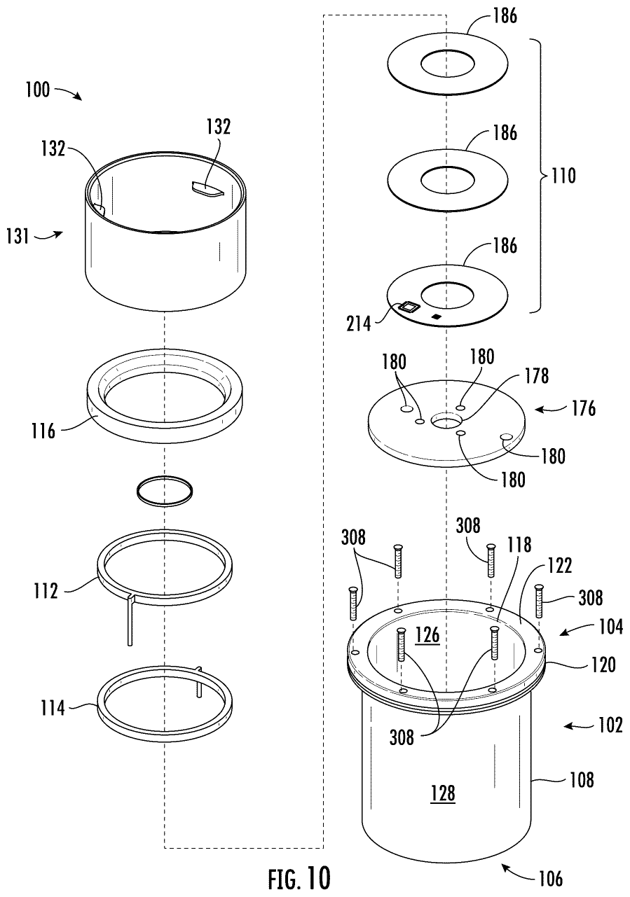

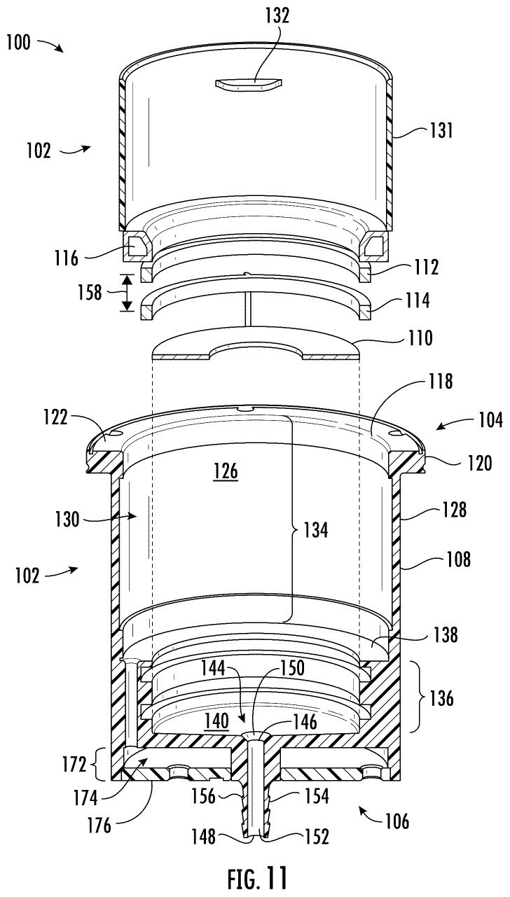

Referring now to FIGS. 7-11, in the example shown, the first conductive ring 112 and second conductive ring 114 are embedded in the sidewall 108 and extend radially from the inner surface 126 toward the outer surface 128. In the example shown, the first conductive ring 112 and second conductive ring 114 have squared-off edges, but they may also be rounded or otherwise shaped. The first conductive ring 112 and second conductive ring 114 are made from a conductive material, such as brass, copper, aluminum, iron, steel, gold, or the like, or an alloy of one or more of the foregoing. The first conductive ring 112 and second conductive ring 114 do not contact each other and are a distance 158 apart.

In the example shown, the first conductive ring 112 and second conductive ring 114 include respective attachment portions 160. The attachment portion 160 of the first conductive ring 112 is in electrical communication with a negative terminal 162 of a battery 164 via a first wire 166. The attachment portion 160 of the second conductive ring 114 is in electrical communication with a positive terminal 168 of a battery 164 via a second wire 170. The second wire 170 includes a NFC-controlled switch 171 which can be opened to disrupt electrical communication between the positive terminal 168 and the second conductive ring 114. In use, the first conductive ring 112 is sometimes in electrical communication with the second conductive ring 114 such that a circuit is completed between the negative terminal 162 and positive terminal 168 when the NFC-controlled switch 171 is closed.

In other embodiments, the polarity of the respective attachment portions 160 may be reversed, such that the attachment portion 160 of the first conductive ring 112 is in electrical communication with a positive terminal 168 of a battery 164 and the attachment portion 160 of the second conductive ring 114 is in electrical communication with a negative terminal 162 of a battery 164.

In other embodiments, the attachment portion 160 of the first conductive ring 112 is in electrical communication with a hot terminal of an alternating current (AC) system, and the attachment portion 160 of the second conductive ring 114 is in electrical communication with a neutral terminal of the AC system. In other embodiments, the polarity may be reversed.

In the example shown, the second capped end 106 includes an extended portion 172. The extended portion 172 defines a PCB volume 174. A PCB cover 176 is adjacent the extended portion 172 and within the PCB volume 174. The PCB cover 176 defines a center aperture 178. The central drain port 144 extends through the center aperture 178 when the PCB cover 176 is placed adjacent the extended portion 172. The PCB cover 176 also defines fixture apertures 180. Wires connected to the respective attachment portions 160 may extend through respective fixture apertures 180 when the PCB cover 176 is placed adjacent the extended portion 172.

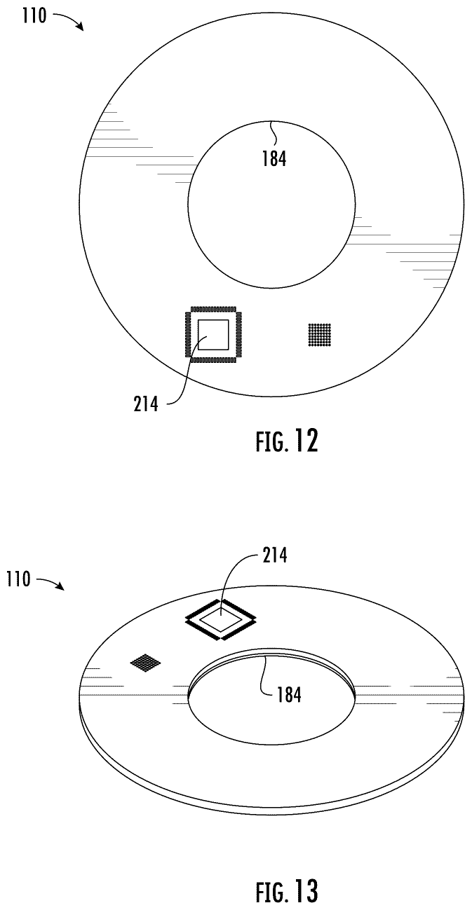

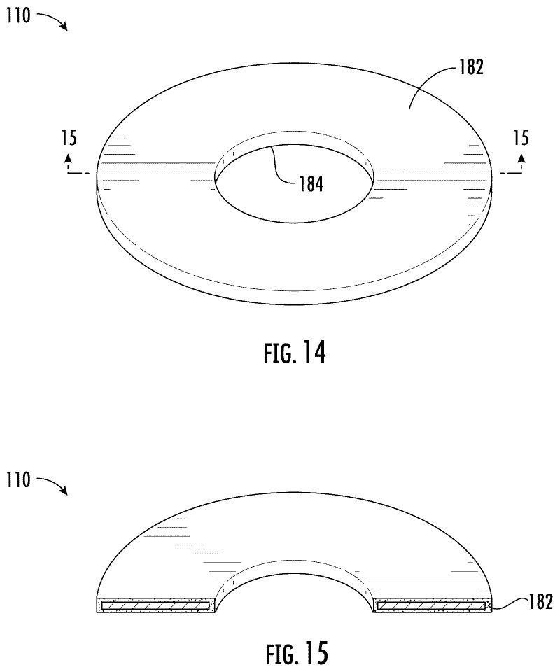

Referring now to FIGS. 7-15, in the example shown, the PCB 110 has an annular shape. As used herein, “annular” shapes include closed and open rings, such as, without limitation, circular rings, like an “O” or “C” shape, square rings, triangular rings, and the like. The PCB 110 may be “potted,” or coated in an insulative, waterproof material 182, to limit interference with the various components of the PCB 110 by external forces, processes, and matter, such as water and oxidation. Potting the PCB 110 also makes it resistant to reverse engineering. The PCB 110 includes a central aperture 184. The PCB 110 may include one layer 186 or multiple layers 186. The PCB 110 is configured to fit within the PCB volume 174 adjacent the second capped end 106. When the PCB 110 is within the PCB volume 174, the central drain port 144 extends through the central aperture 184 of the PCB 110. This allows liquid to drain from the inner volume 130 through the PCB 110 to exit the tubular receptacle 102 without contacting the PCB 110.

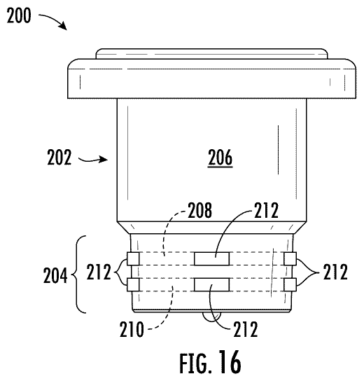

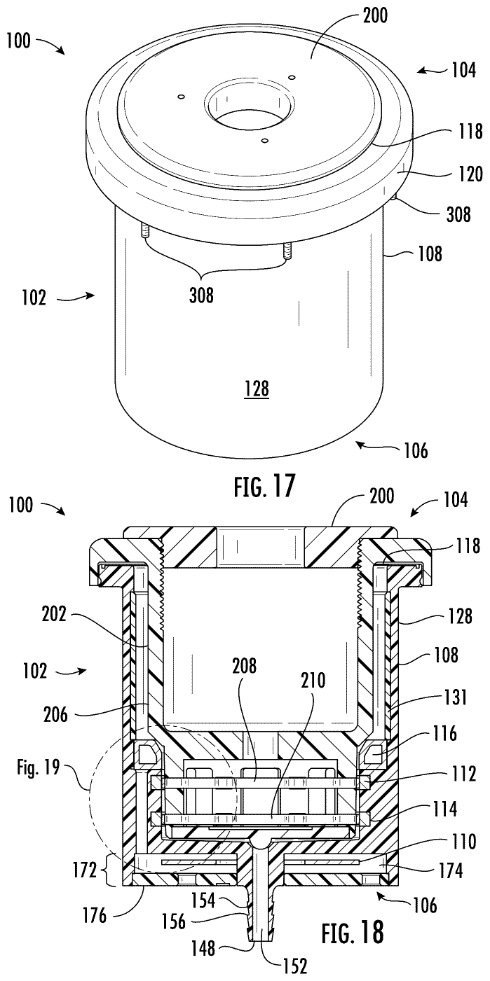

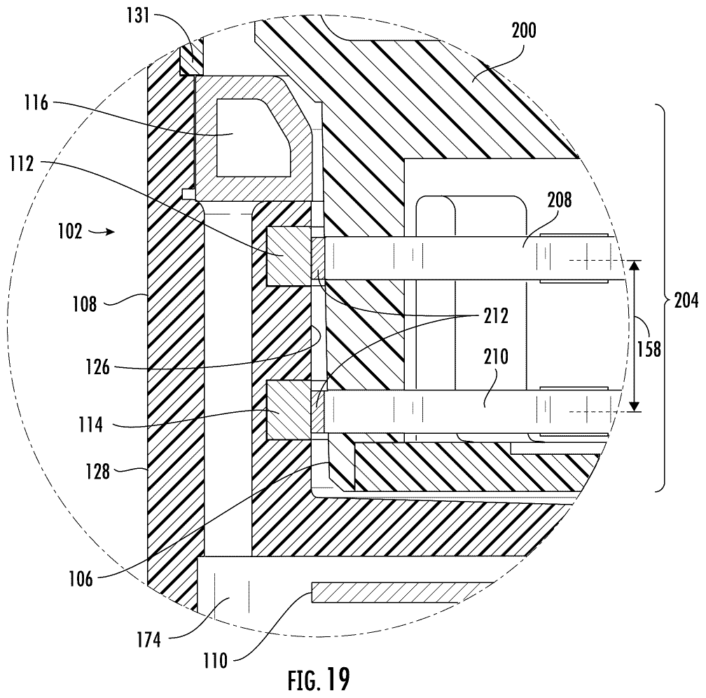

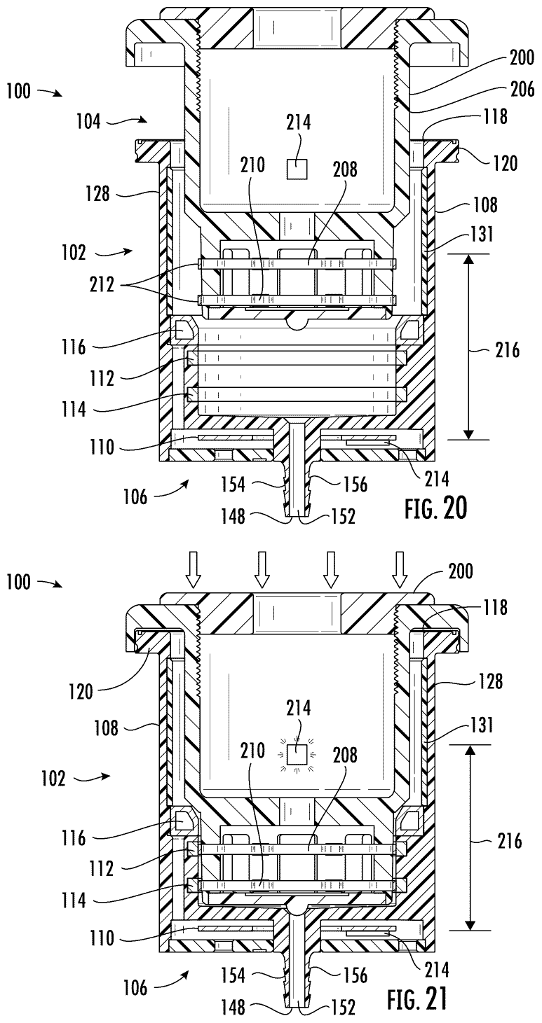

Referring now to FIGS. 16-21 In the example shown, the cupholder 100 also includes an accessory 200. The accessory has a tubular body 202 with a connection portion 204. The connection portion 204 is configured to fit within the tubular receptacle 102. The connection portion 204 has an exterior surface 206, a first loop of conductive ribbon 208, and a second loop of conductive ribbon 210. The first loop of conductive ribbon 208 and the second loop of conductive ribbon 210 are embedded in the tubular body 202 and are separated by the distance 158. Respective contact portions 212 of the first loop of conductive ribbon 208 and second loop of conductive ribbon 210 extend beyond the exterior surface 206. The first loop of conductive ribbon 208 and second loop of conductive ribbon 210 are in electrical communication with each other.

In the example shown, the first loop of conductive ribbon 208 and second loop of conductive ribbon 210 are in substantially parallel planes. As used herein, objects being in “substantially parallel planes” means that the respective objects lie substantially in respective separate planes that will never intersect.

When the accessory 200 is placed within the tubular receptacle 102, a contact portion 212 of the first loop of conductive ribbon 208 contacts the first conductive ring 112, and a contact portion 212 of the second loop of conductive ribbon 210 contacts the second conductive ring 114. An electrical circuit is completed. Current flows from the negative terminal 162 to the first conductive ring 112, to the first loop of conductive ribbon 208, to the accessory 200, to the second loop of conductive ribbon 210, to the second conductive ring 114, to the positive terminal 168. Current is supplied to the accessory 200.

The accessory 200 can include, for example and without limitation, a USB port, a USB-c port, a Lightning® connector port, a battery, a navigation system, depth finder, or other marine electronic apparatus such as those manufactured by Humminbird®, a radio receiver, transmitter, or transceiver, or the like.

In the example shown, the accessory 200 and PCB 110 include respective near field communication (NFC) modules 214. The NFC module 214 on the PCB 110 is configured to enter wireless communication with the NFC module 214 on the accessory 200 when the respective NFC modules 214 are separated by less than a threshold distance 216.

Referring now to FIGS. 9 and 20-21, in the example shown, the PCB 110 is programmed to allow current to flow from the negative terminal 162 of the battery 164 to the first conductive ring 112, to the first loop of conductive ribbon 208, to the accessory 200, to the second loop of conductive ribbon 210, to the second conductive ring 114, to the positive terminal 168 of the battery 164 when the respective NFC modules 214 are separated by less than the threshold distance 216. In the example shown, this is accomplished by the PCB 110 causing the NFC-controlled switch 171 to close. When the respective NFC modules 214 are separated by more than the threshold distance 216, the PCB 110 is configured to cause the NFC-controlled switch 171 to open, disrupting electrical communication between the second conductive ring 114 and the positive terminal 168 of the battery 164. In other examples, the negative terminal 162 of the battery 164 and the positive terminal 168 of the battery 164 may be replaced by other kinds of electrical terminals, such as hot and neutral terminals of an AC system. In other examples, electrical communication between the respective components can be disrupted by operation of a transistor, fuse, breaker, or the like.

In use, the respective NFC modules 214 are separated by more than the threshold distance 216 when the accessory 200 is not fully seated within the cupholder 100. When the accessory 200 is inserted into the tubular receptacle 102 and pushed downward such that it fully seats within the cupholder 100, the respective NFC modules 214 are separated by less than the threshold distance 216, and the accessory 200 can operate with electrical current.

Disrupting electrical communication between respective components when the respective NFC modules 214 are separated by more than the threshold distance 216 allows for safer implementation of the cupholder 100 in marine environments for at least two reasons. First, the NFC modules 214 can implement methods of encryption such that only NFC modules 214 produced by the manufacturer of the cupholder 100 or with the manufacturer's authorization will communicate with the NFC module 214 in the cupholder 100. Thereby, the manufacturer can ensure that only approved accessories 200 are usable in its cupholders 100, as opposed to accessories 200 the safety of which cannot be verified by the manufacturer. Second, because current will only flow between the first conductive ring 112 and second conductive ring 114 when respective NFC modules 214 are separated by less than the threshold distance 216, only an accessory 200 with an appropriate NFC module 214 can cause current to flow between the first conductive ring 112 and second conductive ring 114. Foreign conductive objects, such as water, coins, fish hooks, tools, or the like, or a person's appendage or other body part, cannot complete a circuit between the first conductive ring 112 and second conductive ring 114. This limits the risks of electrocution of users, unintentional drain on a battery 164 or other power source, and other undesirable effects of unintentional current flow.

In other embodiments, a PCB in the accessory 200 is configured to allow current to flow from the second loop of conductive ribbon 210 to the first loop of conductive ribbon 208 when the respective NFC modules 214 are separated by less than the threshold distance 216. When the respective NFC modules 214 are separated by more than the threshold distance 216, a module in the accessory is configured to disrupt electrical communication between the first loop of conductive ribbon 208 and the second loop of conductive ribbon 210. Electrical communication between the respective components can be disrupted by operation of a switch, transistor, or the like.

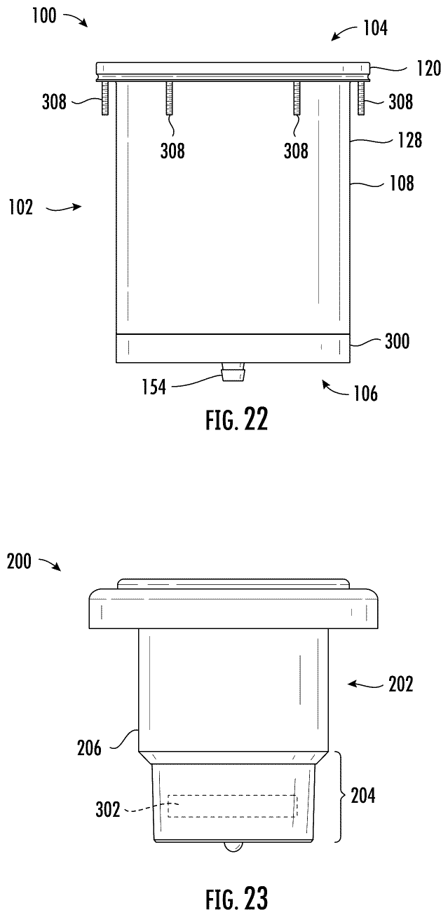

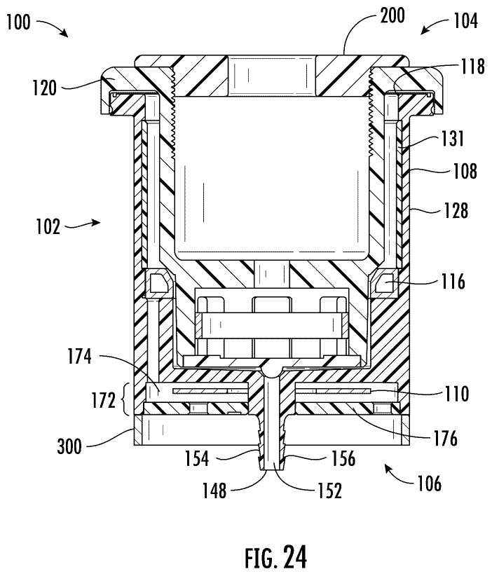

Referring now to FIGS. 22-24, a second example of a cupholder 100 includes a tubular receptacle 102, an extended portion 172, a PCB volume 174 within the extended portion 172, and an accessory 200. As compared to the first example, current is supplied to the accessory 200 in a different manner. In this example, the cupholder 100 does not have a first conductive ring 112 or a second conductive ring 114, but other examples may have these features. The accessory 200 does not have a first loop of conductive ribbon 208 or a second loop of conductive ribbon 210, but other examples may have these features. The cupholder includes a first inductive loop 300 adjacent a second capped end 106 of the tubular receptacle 102. In other examples, the first inductive loop 300 may be within the PCB volume 174. The first inductive loop 300 is in electrical communication with an AC power source (not shown). A second inductive loop 302 is within the connection portion 204. When the accessory 200 is in the tubular receptacle 102, alternating current through the first inductive loop 300 induces alternating current in the second inductive loop 302. Current is thereby supplied to the accessory 200.

As compared to the first example, the second example of a cupholder 100 has the advantage that, due to the use of electromagnetic induction rather than direct electrical contact, all electrical components of the cupholder 100 can be insulated from environment, including conductors such as water or metal objects.

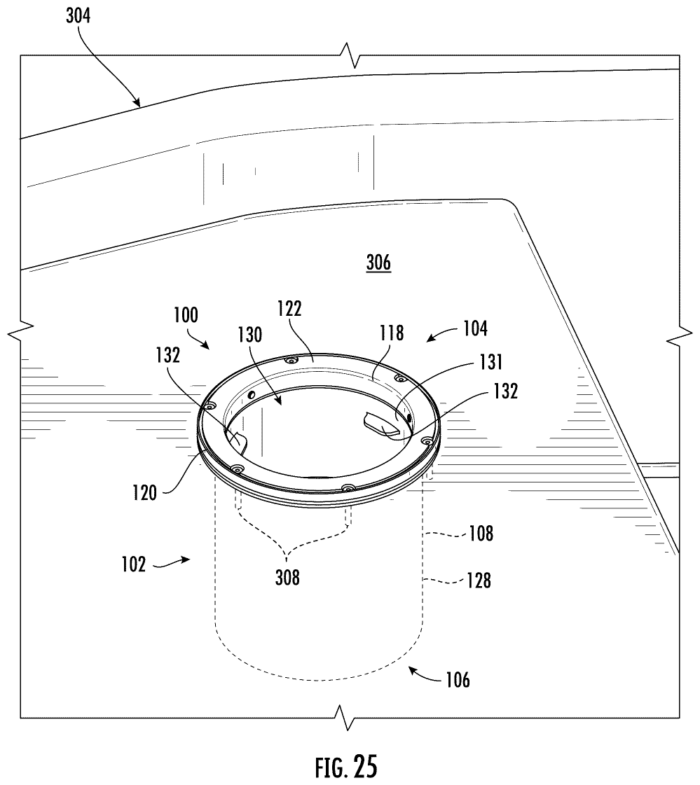

Referring now to FIG. 25, in the example shown, the cupholder 100 is affixed to a boat 304. In other examples, the cupholder 100 may be affixed to a jet ski, motorcycle, all-terrain vehicle, or other vehicle, or to a building, chair, deck, or other structure or item. The mounting face 124 of the radially enlarged lip 120 is flush with a surface 306 of the boat 304. The mounting face 124 may be affixed to the surface 306 via adhesive, screws 308, nails, clips, clamps, or the like. In the example shown, the mounting face 124 is affixed to the surface 306 via mounting screws 308.

The cupholder is not limited to the details described in connection with the examples described here. There are numerous variations and modifications of the cupholder that may be made without departing from the scope of what is claimed.

That which is claimed is:

1. A cupholder comprising:
a tubular receptacle with a first open end, a second capped end, and a sidewall therebetween, the second capped end defining a central drain port;
an annular PCB adjacent the second capped end, the annular PCB having a central aperture;
wherein the central drain port extends through the central aperture.

2. The cupholder of claim 1, further comprising an inductive loop adjacent the second capped end.

3. The cupholder of claim 1, further comprising:
an inductive loop adjacent the second capped end; and
an accessory with a tubular body, the tubular body having a connection portion configured to fit within the tubular receptacle, and an inductive loop within the connection portion.

4. The cupholder of claim 1, wherein the annular PCB includes a NFC module.

5. The cupholder of claim 1, wherein the annular PCB is coated in an insulative, waterproof material.

6. The cupholder of claim 1, further comprising an annular LED module within the tubular receptacle.

7. The cupholder of claim 1, wherein:
the sidewall has an inner surface and an outer surface; and
further comprising:
a first conductive ring embedded in the sidewall and extending radially from the inner surface toward the outer surface; and
a second conductive ring embedded in the sidewall and extending radially from the inner surface toward the outer surface;
the second conductive ring being a distance from the first conductive ring.

8. The cupholder of claim 1, further comprising an accessory with a tubular body, the tubular body having a connection portion configured to fit within the tubular receptacle.

9. The cupholder of claim 1, wherein:
the sidewall has an inner surface and an outer surface; and
further comprising:
a first conductive ring embedded in the sidewall and extending radially from the inner surface toward the outer surface;
a second conductive ring embedded in the sidewall and extending radially from the inner surface toward the outer surface;
the second conductive ring being a distance from the first conductive ring;
an accessory with a tubular body, the tubular body having a connection portion configured to fit within the tubular receptacle, the connection portion having an exterior surface, a first loop of conductive ribbon, and a second loop of conductive ribbon;
the first loop of conductive ribbon and second loop of conductive ribbon being embedded in the tubular body and having respective contact portions that extend beyond the exterior surface;
the second loop of conductive ribbon being the distance from the first loop of conductive ribbon.

10. The cupholder of claim 1, further comprising:
a first NFC module on the annular PCB; and
an accessory with a tubular body, the tubular body having a connection portion configured to fit within the tubular receptacle, the connection portion having a second NFC module;
wherein the annular PCB is programmed to allow current to flow through the tubular receptacle and the connection portion when the first NFC module and second NFC module are separated by less than a threshold distance.

11. A cupholder comprising:
a tubular receptacle with a first open end, a second capped end, and a sidewall therebetween, the sidewall having an inner surface and an outer surface;
a first conductive ring embedded in the sidewall and extending radially from the inner surface toward the outer surface;
a second conductive ring embedded in the sidewall and extending radially from the inner surface toward the outer surface;
the second conductive ring being a distance from the first conductive ring.

12. The cupholder of claim 11, further comprising an annular PCB adjacent the second capped end.

13. The cupholder of claim 11, further comprising an annular PCB adjacent the second capped end, the annular PCB being coated in an insulative, waterproof material.

14. The cupholder of claim 11, further comprising an annular PCB adjacent the second capped end;
wherein the second capped end defines a central drain port that extends through the annular PCB.

15. The cupholder of claim 11, further comprising an annular LED module within the tubular receptacle.

16. The cupholder of claim 11, further comprising an annular PCB adjacent the second capped end, the annular PCB including a NFC module.

17. The cupholder of claim 11, further comprising:
an accessory with a tubular body, the tubular body having a connection portion configured to fit within the tubular receptacle, the connection portion having an exterior surface, a first loop of conductive ribbon, and a second loop of conductive ribbon;
the first loop of conductive ribbon and second loop of conductive ribbon being embedded in the tubular body and having respective contact portions that extend beyond the exterior surface;
the second loop of conductive ribbon being the distance from the first loop of conductive ribbon.

18. The cupholder of claim 11, further comprising:
an accessory with a tubular body, the tubular body having a connection portion configured to fit within the tubular receptacle, the connection portion having an exterior surface, a first loop of conductive ribbon, and a second loop of conductive ribbon;
the first loop of conductive ribbon and second loop of conductive ribbon being embedded in the tubular body and having respective contact portions that extend beyond the exterior surface;
the second loop of conductive ribbon being the distance from the first loop of conductive ribbon;
the first loop of conductive ribbon and the second loop of conductive ribbon being in substantially parallel planes.

19. The cupholder of claim 11, further comprising:
an annular PCB adjacent the second capped end, the annular PCB including a first NFC module;
an accessory with a tubular body, the tubular body having a connection portion configured to fit within the tubular receptacle, the connection portion having a second NFC module;
wherein the annular PCB is programmed to allow current to flow from the first conductive ring through the accessory to the second conductive ring when the first NFC module and second NFC module are separated by less than a threshold distance.

20. A cupholder comprising:
a tubular receptacle with a first open end, a second capped end, and a sidewall therebetween, the sidewall having an inner surface and an outer surface, the second capped end defining a central drain port;
an annular PCB adjacent the second capped end, the annular PCB having a central aperture and a first NFC module and being coated in an insulative, waterproof material;
the central drain port extending through the central aperture;
a first conductive ring embedded in the sidewall and extending radially from the inner surface toward the outer surface;
a second conductive ring embedded in the sidewall and extending radially from the inner surface toward the outer surface;
the second conductive ring being a distance from the first conductive ring;
an annular LED module within the sidewall; and
an accessory with a tubular body, the tubular body having a connection portion configured to fit within the tubular receptacle, the connection portion having a second NFC module, an exterior surface, a first loop of conductive ribbon, and a second loop of conductive ribbon;
the first loop of conductive ribbon and second loop of conductive ribbon being embedded in the tubular body and having respective contact portions that extend beyond the exterior surface;
the second loop of conductive ribbon being the distance from the first loop of conductive ribbon;
the first loop of conductive ribbon and the second loop of conductive ribbon being in substantially parallel planes;
wherein the annular PCB is programmed to allow current to flow from the first conductive ring through the first loop of conductive ribbon and second loop of conductive ribbon to the second conductive ring when the first NFC module and second NFC module are separated by less than a threshold distance.
